(19) United States
(12) Patent Application Publication
(10) Pub. No.: US 2003/0188948 A1
(43) Pub. Date: Oct. 9, 2003

(54) Ball screw actuated differential lock

(75) Inventor: Richard M. Krzesicki, Ann Arbor, MI (US)

Correspondence Address: BRINKS HOFER GILSON & LIONE, P.O. BOX 10395, CHICAGO, IL, 60611, US

(73) Assignee: Visteon Global Technologies, Inc.

(21) Appl. No.: 10/115,543

(22) Filed: Apr. 3, 2002

(51) Int. Cl. F16D 27/00

(52) U.S. Cl. 192/84.6; 192/94; 74/89.23

(57) ABSTRACT

An apparatus for applying a load to a clutch pack system in a vehicle comprising a motor having a shaft for providing torque, a gearset interfacing with the shaft, a ball screw mechanism linked to the gearset including a ball screw having helically extending retention grooves and lands and a ball nut having a ball nut path and lands on the inner face of the ball nut. The ball nut includes a return passage and is threadably mounted to the ball screw and thus defines a pathway extending from a first end to a second end of the ball nut. The pathway captures a plurality of spherical balls between the ball nut and the ball screw, the balls being configured for circulation through the return passage and around a portion of the helically extending retention grooves. The apparatus also includes a thrust bearing axially interfaced with the ball nut and a load ring movable by the thrust bearing as well as a plurality of pins from the load ring and extending in an axial direction to interface with the clutch pack system.

### FIELD OF THE INVENTION

The present invention generally relates to automobile differentials. In particular, the invention relates to a differential lock that may be actuated by a ball screw mechanism.

### BACKGROUND OF THE INVENTION

Ball screw mechanisms act as linear actuators that transmit an axial force from rotary motion with minimum friction. Ball screw mechanisms are used in applications such as, for example, automotive systems, machine tool tables and linear actuators, jacking and positioning mechanisms, aircraft controls such as flap actuating devices, packaging equipment, instruments, and many similar systems.

Typically, the ball screw mechanism includes a helically threaded screw extending through an opening in a threaded nut. The threads trap a plurality of spherical ball bearings between the nut and the screw. When the screw rotates relative to the nut, the balls are diverted from one end of the ball nut and are carried by ball guides to the opposite end of the ball nut. Recirculation permits unrestricted axial travel of the nut relative to the screw without the passing of the balls out of the mechanism.

One important application parameter surrounding the selection of a ball screw mechanism is the axial load to be exerted by the screw during rotation. The flexibility in selecting such a load to be exerted is paramount to the effectiveness of the ball screw mechanism application. Ball ramp mechanisms have been used in the past to aid in the application of loads on systems such as those described above. Ball ramp mechanisms generally include a small number of load-bearing balls and a ramp system housed in a ring-like device that includes grooves in which the load-bearing balls traverse. The grooves usually have angular pitch or inclination relative to the face of the device that varies along the length of the grooves. When the ball ramp mechanism is engaged, the ring-like device begins angular rotation and the load-bearing balls begin to move up the angular pitch along the grooves. This angular movement of the balls helps stimulate axial movement of the rest of the system, thus applying a load to the system. For ball ramp designs, however, one half of the ring-like device must rotate and cannot rotate greater than 360 degrees divided by the number of balls employed in the mechanism. If the system were to rotate greater than 360 degrees divided by the number of load-bearing balls, the balls would disengage from the grooves resulting in a lack of axial load application to the system. The amount of axial force generated is directly related to the angular limitations of the ball ramp mechanism and the number of load-bearing balls in the system. For example, if a 100-degree angle of rotation of is needed, only three balls would be able to be used and thus generation of a large axial load would be unlikely. Because of this limitation, ball ramp mechanisms are not advantageous for applications that require a large load application, such as a load application to a clutch pack system in a vehicle.

Clutch pack systems usually include stamped metal disks with a friction material glued onto the flat surface of each individual disk. When the clutch system of a vehicle is engaged, two shafts are engaged by the clutch packs at two different speeds (for example, when a vehicle is turning). The speed difference causes the clutch pack disks to rub against each other. This continues until the two shafts, coupled by the clutch pack, attain the same speed. This rubbing of the clutch pack disks causes the friction material to wear and thus the disks themselves to wear.

Ball ramp mechanisms have not been advantageous to accommodate such wearing of the clutch pack system. For example, as the clutch pack system wears, the ball ramp mechanism would be required to translate a greater axial distance to apply the load to the system. Once this translational distance becomes too great, the balls within the ball ramp mechanism have a tendency to dislodge from their respective grooves and either fall out of the system or jump to another groove.

In applications such as torque biasing in vehicular applications and systems, mechanisms are needed that can accommodate a large amount of axial force generated by sudden uses of an axle differential. Axle differentials allow a vehicle's front wheels to turn at different rates since, when making a turn, the outer wheel will be traveling farther than the inner wheel. Sudden uses of an axle differential would occur, for example, when a vehicle encounters snow or another slippery surface in which the tires become caught and otherwise are unable to perform safely. The torque associated with the mechanics of turning a vehicle, sometimes called driveline torque, cannot at this point enable the vehicle to turn properly. It is thus advantageous to have a system that can correct or even anticipate such errors before they are likely to occur and signal, for example, a motor to engage and apply the appropriate torque biasing to the clutch system of a vehicle.

### SUMMARY

To allow for torque biasing, the preferred embodiment of the present invention includes an actuating device that provides the torque necessary for such a system. A motor with a shaft is included and interfaced with a gearset that provides the necessary torque multiplication to each particular application of the present invention. To accommodate a varied amount of torque multiplication, a ball screw mechanism is linked to the gearset that includes a ball screw having a helically extending retention groove as well as a land to form a thread-like member. The ball screw mechanism also includes a ball nut threadably mounted to the ball screw with groove-like paths and lands on the inner face of the nut so as to form a helical pathway extending from the first end of the nut to the second end of the nut. The pathway is capable of capturing a plurality of spherical load-bearing balls for circulation around the helically extending retention grooves and through a return passage preferably included in the nut. A thrust bearing axially interfaces the nut and moves a load ring. Pluralities of pins extend axially from the load ring and interface with a clutch pack system and preferably apply a force to an axially mounted clutch pack system.

The apparatus in the preferred embodiment of the present invention overcomes several of the design limitations of previous applications by implementing a ball screw mechanism including an increased number of spherical load-bearing balls. As shown above, traditional ball ramp mechanisms have been used in the past but have been insufficient when a clutch pack begins to wear. The implementation of a ball screw mechanism is advantageous because of the ability to significantly increase the number of load-bearing balls into the mechanism. Axial loads are thus more widely distributed among the balls when the number of balls is increased, allowing for a larger useful load range for the mechanism.

Another aspect of the preferred embodiment of the present invention is the inclusion of a hollow ball screw that is configured to accept numerous axial devices such as differential cases, vehicular axles, and the like.

### DESCRIPTION OF THE DRAWINGS

FIG. 1 illustrates a first embodiment of the apparatus of the present invention;

FIG. 2 illustrates a first embodiment of the ball screw mechanism of the present invention having a one-track recirculating configuration;

FIG. 3 illustrates a second embodiment of the ball screw of the present invention having a two-track recirculating configuration;

FIG. 4 illustrates an enlarged view of the first embodiment of the ball screw mechanism of the present invention having a one-track recirculating configuration;

FIG. 4a illustrates an enlarged view of the ball screw of the present invention.

### DETAILED DESCRIPTION OF THE PREFERRED EMBODIMENTS

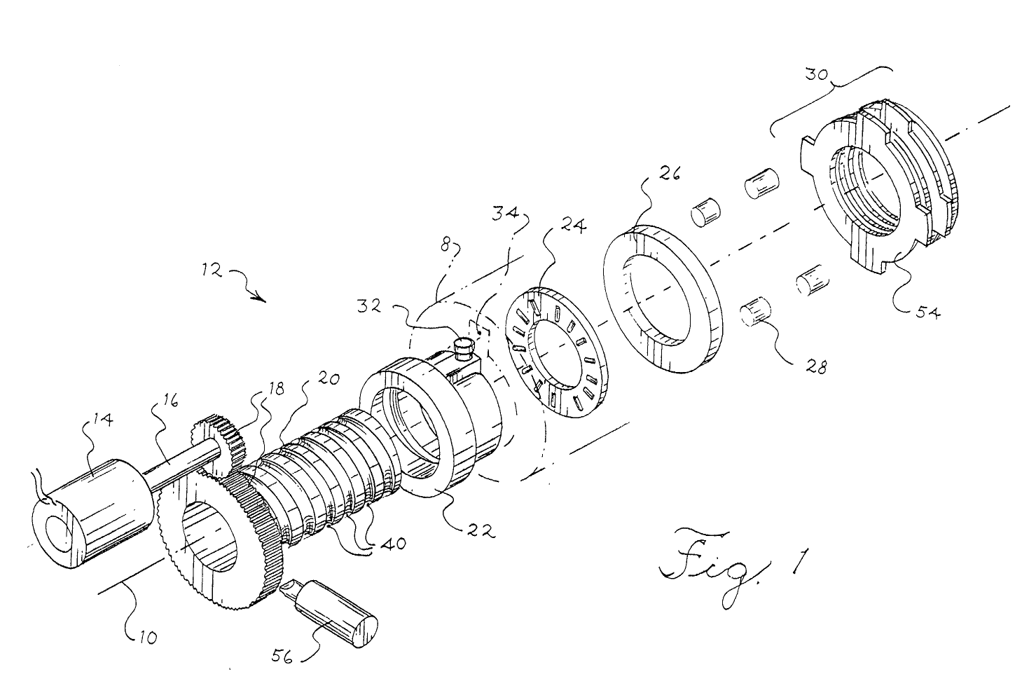

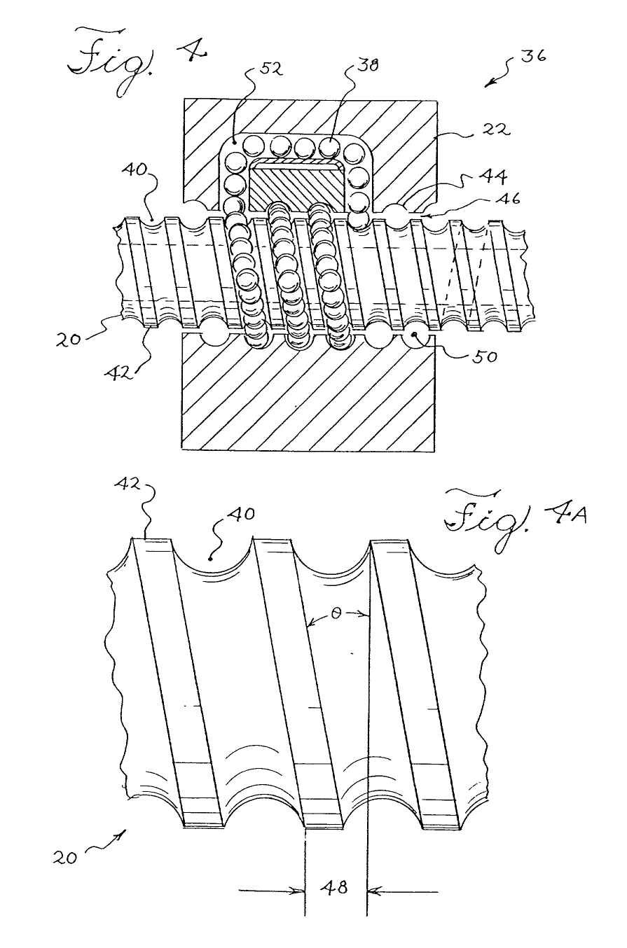

Turning to the drawings, FIGS. 1, 4, and 4a illustrate a first embodiment of the present invention. Referring to FIG. 1, a motor 14 for continuously variable speed transmission is located at one end of the load-applying apparatus 12. For illustration purposes, the axis 10 is included and is freely rotatable within and extends through the load-applying apparatus 12. An external housing 8 is shown and can be any housing appropriate for the applications described herein. The axis 10 preferably extends through the center axis of a differential case or an axle of the vehicle. The motor 14 preferably is electric and operates at high revolutions per minute to generate low torque. However, the motor 14 may be any device capable of actuating a system such as the load-applying apparatus 12 and may incorporate, for example, hydraulic or pneumatic means.

The motor 14 preferably includes a shaft 16 that interfaces with a gearset 18 located opposite of the motor 14 along the shaft 16. The gearset 18 may be configured as is known in the art and preferably at least includes a smaller spur gear and a larger spur gear that mesh with each other and are capable of multiplying torque. The gearset 18 preferably multiplies the torque from the motor 14 by a 5:1 ratio, although any ratio of torque multiplication is sufficient for this and other embodiments of the present invention. The gearset 18 is coupled by conventional means to one end of a ball screw 20. The use of other gearing systems known in the art will also be appropriate. The gearset 18 operates to multiply and apply torque to the ball screw 20 such that the ball screw 20 can rotate freely about the axis 10. In the preferred embodiment, the ball screw 20 is hollow such that an axle may pass through it, thus allowing the ball screw 20 to be freely rotatable within and independent of the axle and its associated rotation.

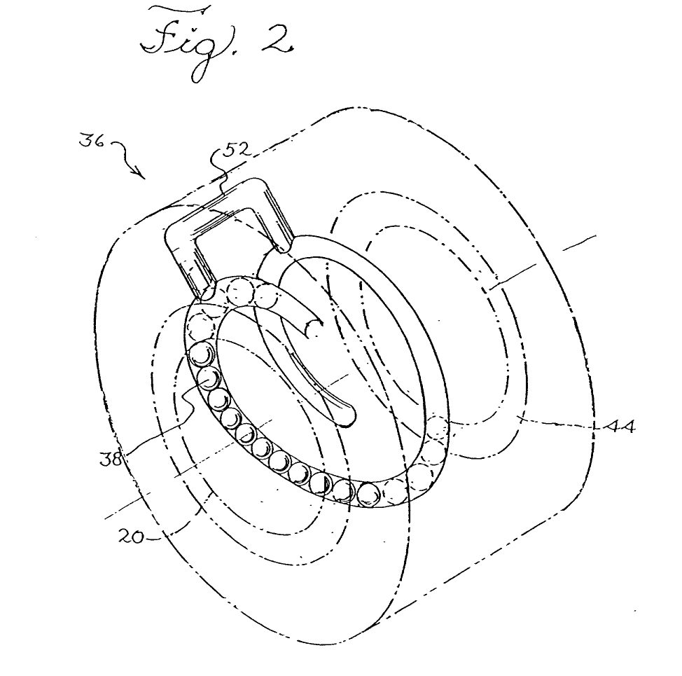

Referring now to FIGS. 2, 4, and 4a, a ball screw mechanism assembly is shown generally at 36 and includes a ball screw 20 with a helically extending retention groove 40 and land 42, a ball nut 22 with a ball nut path 44 and a land 46, and spherical balls 38 interposed therebetween. The ball nut path 44 is complementary to the helically extending retention groove 40 and cooperates with the helically extending retention groove 40 to enable positioning of the spherical balls 38 between the ball screw 20 and the ball nut 22. The helically extending retention groove 40 of the ball screw 20 preferably encompasses nearly the entire length of the ball screw 20. A portion of the helically extending retention groove 40 and a portion of the land 42 define a lead 48, as shown in FIG. 4a. The lead 48 is the width between the leading side of the land 42 and the opposing side of the helically extending retention groove 40 most closely associated with the land 42. In the preferred embodiment, the lead 48 is relatively narrow. As the lead 48 becomes narrower, the spherical balls 38 become more tightly interposed between the ball screw 20 and the ball nut 22. This tighter interposition allows for the increase in the resultant rotary/axial force ratio which thereby allows for greater generation of load or force throughout the load-applying apparatus 12.

The ball screw mechanism 36 enables the transformation of a rotary moment into linear motion with a ramp angle, shown for illustration purposes as θ, thus providing the ability to generate more axial load or force throughout the load-applying apparatus 12. For example, if the ramp angle θ is increased, the resultant rotary/axial force ratio is decreased. Conversely, if the ramp angle θ is decreased then the resultant rotary/axial force ratio is increased.

The ball nut 22 is threadably mounted about the ball screw 20. Preferably, the ball nut 22 is generally cylindrical in nature and may translate axially along the load-applying apparatus 12. A ball nut path 44 and a land 46 are defined on the inner face of the ball nut 22 and preferably encompass the entire length of the ball nut 22. The ball nut path 44 and land 46 complement the helically extending retention groove 40 and the land 42 of the ball screw 20 such that a pathway 50 is formed. The pathway 50 accommodates a plurality of spherical balls 38 and is generally tubular in shape. The spherical balls 38 within the pathway 50 preferably are capable of bearing the axial force that is generated between the ball nut 22 and the ball screw 20. The balls 38 preferably travel the length of the pathway 50, which preferably extends from one end of the helically extending retention groove 40 to the other.

In one embodiment of the invention, as shown in FIGS. 2 and 4, the ball nut 22 preferably includes a return passage 52 that enables the spherical balls 38 to circulate through the ball screw mechanism assembly 36. The return passage 52, generally tubular in shape, has an axial portion that is parallel to the axis of the ball screw 20. The axial portion of return passage 52 preferably extends along a substantial length of the ball screw 20 resulting in the capability of more spherical balls 38 being recirculated throughout the ball screw mechanism 36. While an internal return passage is shown, it is understood that the passage could be external as well.

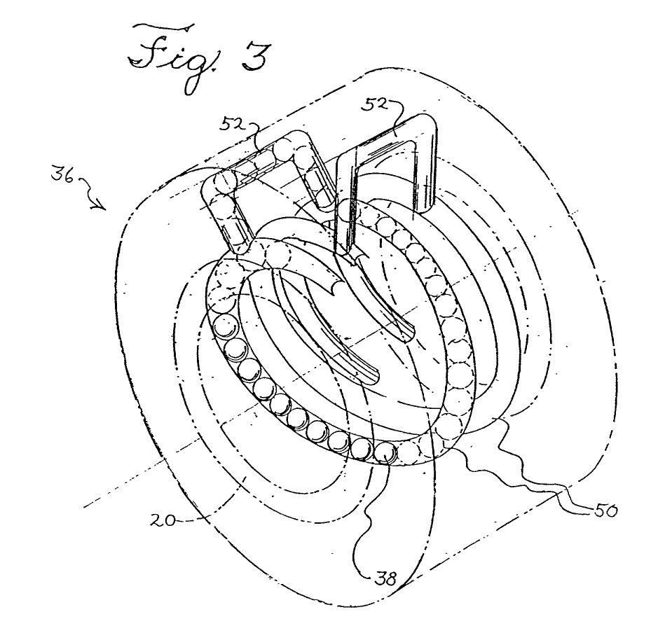

As shown in FIG. 3, another embodiment of the present invention includes the ball screw mechanism assembly 36 assembled in a similar manner as described above having a ball screw 20 with a ball nut 22 threadably mounted about the ball screw 20. However, in this embodiment there are multiple pathways 50. Each pathway 50 holds a plurality of spherical balls 38. This embodiment is advantageous because it allows for an increase in the amount of spherical balls 38 that can be circulated through the ball screw mechanism assembly 36. As the number of spherical balls 38 increases, the applied load to the load-applying apparatus 12 may be increased thus generating a larger load on the clutch pack system 30. The load being shared among the plurality of spherical balls 38 accomplishes this.

As with the other embodiment to the present invention, the ball nut 22 in the present embodiment may or may not include a return passage 52. If recirculation is desired in this embodiment throughout the ball screw mechanism 36, then the number of return passages 52 must equal the number of pathways 50 such that each independent plurality of spherical balls 38 circulating through each independent pathway 50 may be recirculated through an independent return passage 52.

Referring again to FIG. 1, the ball nut 22 preferably includes a flange 32 fixably attached to and extending outwardly from the ball nut 22. The flange 32 could be, for example, a pin with a roller bearing fixably attached on its end. The flange 32 extends into a guide means such as a groove 34 rigidly mounted to the external housing 8 relative to the motor 14. The flange 32 and the groove 34 prevent substantial rotation of the ball nut 22 relative to the ball screw 20 thus allowing directed, linear movement of the ball nut 22 relative to the ball screw 20.

In the preferred embodiment, when the ball nut 22 moves linearly relative to the ball screw 20, the spherical balls 38 are caused to circulate through the pathway 50 and the return passage 52 while a thrust bearing 24 is axially interfaced with the ball nut 22 to receive an axial force generated by the ball screw mechanism 36. As the spherical balls 38 pass through the return passage 52 and reenter the pathway 50 the spherical balls 38 are constantly being replenished so as to form a substantially continuous line of spherical balls 38. A load ring 26 is positioned to receive an axial force from the thrust bearing 24 and is movable by the thrust bearing 24. Pluralities of pins 28 extending from the load ring 26 extend in an axial direction and interface with a clutch pack system 30. In the preferred embodiment, the clutch pack system 30 is a wet clutch system.

In use, when torque biasing or any other application in which the present invention is applicable is required, the motor 14 is engaged and generates torque. The torque generated by motor 14 is multiplied by gearset 18 and applied to the ball screw mechanism 36 generally comprised of the ball screw 20 and the ball nut 22. The ball screw 20 rotates and causes axial translation of the ball nut 22. The ball nut 22 can translate but cannot rotate due to the flange 32 riding in a guide means such as a groove 34, which is mounted to the external housing 8. The ball screw mechanism 36 is axially interfaced with force applying means that may include the thrust bearing 24, the load ring 26, or the plurality of pins 28, or any combination thereof. The thrust bearing 24 receives an axial force from the ball screw mechanism 36 and pushes on the load ring 26. The load ring 26 then engages the plurality of pins 28 to apply a force to the clutch pack system 30 or whatever may be axially interfaced with the plurality of pins 28.

Referring again to FIG. 1, the clutch pack system 30 is comprised of a plurality of plates 54 with friction material (not shown) affixed to each surface of the disks. The plurality of plates 54 preferably are comprised of stamped metal and the friction material is comprised of, for example, paper, carbon fiber, Kevlar, or any other material sufficient to accommodate the friction generated by the plates 54 when the clutch pack system 30 is engaged. When the load-applying apparatus 12 is actuated, an axial force is applied to the clutch pack system 30 as described above. In vehicular applications, when the axial force is applied to the clutch pack system 30, axle half shafts (not shown) of a vehicle are engaged at two different speeds such as when the vehicle is turning. This speed differential causes the plates 54 to begin to rub together until the axle half shafts (not shown), coupled by the clutch pack system 30, attain the same speed and the torque associated with the axle half shafts is controlled.

Additionally, the load-applying apparatus 12 preferably includes a solenoid 56. The solenoid 56 is preferably of the spring applied/ electric release type. When torque biasing is required, a voltage may be applied via automatic sensors, computers, or manually to the solenoid 56. The solenoid 56 can then unlock the load-applying apparatus 12. When the load applied is at a desired level, the solenoid 56 will lock and the motor 14 will terminate operation. For example, the solenoid 56 is configured to be applied to the gearset 18 such that free rotation of the gearset 18 is prevented. When the solenoid 56 engages the gearset 18, the load-applying apparatus 12 is mechanically locked and the motor 14 is powered off. Selectively operating the motor 14 in this manner is advantageous in preventing motor 14 burnout by preventing the motor 14 from being powered on for long periods of time.

The present invention is particularly advantageous for overcoming the disadvantages of using a ball ramp mechanism in torque biasing applications. As shown in FIG. 4, the ball screw mechanism 36 allows for an increased number of spherical balls 38. The balls 38 pass about the ball screw 20 through the pathways 50 formed by the helically extending retention groove 40 and the ball nut paths 44 without the angular restraints inherent in a ball ramp mechanism. Because the present invention allows a dramatic increase in the number of spherical balls 38 present in the system, the load applied to the system will be shared among the increased number of spherical balls 38 thus allowing for the generation of a larger load applied to the clutch pack system 30. The use of a ball screw mechanism 36 allows for a smoother operation and greater axial extension when, for example, the clutch pack system 30 begins to wear. Furthermore, as the load on the clutch pack system 30 is increased, there is a greater torque biasing capability.

Although the present invention has been described in terms of what will be apparent to those skilled in the art, the present invention is not limited to the above-described embodiments and can be modified in various ways without departing from the scope set forth in the appended claims.

I claim:

1. An apparatus for applying a load to a clutch pack system in a vehicle, said apparatus comprising:
a motor having a shaft for providing torque;
a gearset interfacing with said shaft;
a ball screw mechanism linked to said gearset, said ball screw mechanism including a ball screw having a helically extending retention groove and a land, and said ball screw mechanism including a ball nut having a ball nut path and land on the inner face of said ball nut, said ball nut including a return passage and said ball nut being threadably mounted to said ball screw and defining a pathway extending from a first end of said ball nut to a second end of said ball nut, said pathway capturing a plurality of spherical balls between said ball nut and said ball screw, said plurality of balls configured for circulation through said return passage and around a portion of said helically extending retention groove;
a thrust bearing axially interfaced with said ball nut;
a load ring movable by said thrust bearing; and
a plurality of pins extending from said load ring in an axial direction for applying a load to said clutch pack system.

2. The apparatus of claim 1 wherein said clutch pack system includes at least one clutch plate.

3. The apparatus of claim 1 wherein said motor is an electric motor.

4. The apparatus of claim 1 further comprising a flange extending outwardly from said nut, said flange extending into a guide means rigidly mounted relative to said motor, said guide means adapted to prevent substantial rotation of said nut relative to said screw and to allow linear movement of said nut relative to said screw.

5. The apparatus of claim 1 wherein rotational movement of said ball screw causes linear axial movement of said nut along the axis of said ball screw.

6. The apparatus of claim 5 wherein movement of said nut along said ball screw causes said balls to circulate through said return passage and said pathway.

7. The apparatus of claim 5 wherein axial force generated between said nut and said screw is borne by a plurality of said balls circulating positioned within said pathway.

8. The apparatus of claim 1 wherein said ball screw is hollow.

9. The apparatus of claim 8 wherein an axle is received in said ball screw.

10. The apparatus of claim 1 wherein said clutch pack system is axially actuatable.

11. A method of applying a force to a clutch pack to control torque biasing created by an axle differential in a vehicle, said method comprising the steps of:
providing a motor linked to an axially mounted ball screw mechanism having a linearly movable ball nut, said ball nut including a return passage and being threadably mounted to a ball screw;
providing a plurality of spherical balls between said ball nut and said ball screw for circulation through said return passage and around said ball screw;
selectively operating said motor to advance said ball nut to transmit an axial force to said clutch pack.

12. The method of claim 11 wherein said clutch pack is a wet clutch pack.

13. The method of claim 11 wherein said motor is an electric motor.

14. The method of claim 11 further comprising a gearset wherein said gearset provides a 5:1 torque multiplication.

15. The method of claim 11 wherein rotational movement of said ball screw causes linear axial movement of said nut along the axis of said ball screw.

16. The method of claim 15 wherein movement of said nut along said ball screw causes said balls to circulate through said return passage and said pathway.

17. The method of claim 11 wherein axial force generated between said nut and said screw is borne by a plurality of said balls circulating within said pathway.

18. The method of claim 11 wherein said ball screw defines a bore extending axially therefrom.

19. The method of claim 18 wherein an axle is received in said ball screw.

20. A load-applying apparatus for applying an axial load to an axially mounted clutch pack, said apparatus comprising:
rotary means for applying a torque; and
axially mounted ball screw means in communication with said rotary means, said ball screw means including a linearly movable nut having recirculating means defined therein for recirculating a plurality of spherical balls through said ball screw means;
said ball screw means axially interfaced with force applying means for applying an axial load to said clutch pack.
